(19) United States
(12) Patent Application Publication
(10) Pub. No.: US 2016/0309229 A1
(43) Pub. Date: Oct. 20, 2016

(54) Recommendation And Unification Of Related Assets For Recording

(71) Applicant: Comcast Cable Communications, LLC, Philadelphia, PA (US)

(72) Inventors: Bruce Bradley, Philadelphia, PA (US); Walter Michel, Philadelphia, PA (US); Mark McKelvey, Philadelphia, PA (US); Rob Holmes, Philadelphia, PA (US); Dan Carella, Philadelphia, PA (US); William Sheahan, Philadelphia, PA (US); Ryan Crouch, Philadelphia, PA (US)

(21) Appl. No.: 14/691,025

(22) Filed: Apr. 20, 2015

(51) Int. Cl. H04N 21/472; H04N 21/4147; H04N 21/482; H04N 21/488; H04N 21/6543; H04N 21/262

(52) U.S. Cl. CPC H04N 21/472; H04N 21/6543; H04N 21/262; H04N 21/482; H04N 21/4888; H04N 21/4147

(57) ABSTRACT

Methods and systems for directing a user to desired content are described. In an aspect, a user can be directed to desired content through content bundling. As an example, in response to a user setting a digital video recorder (DVR) to record a particular program, a set of programs based on the particular program can also be recorded on the file and/or suggested to the user for recording. The order that the programs appear in the file is determined by a logical sequence, such as the order in which the programs first aired. In an aspect, a user can be directed to desired content during a particular point in current content, such as when the end credits begin to roll. The desired content can be identified as desired content based on the current content.

### BACKGROUND

Consumers of content have many content options available. The amount of content options can be overwhelming and, as a result, the consumer can miss out on storing desired content for future viewing. Consumers can also miss desired linear content that is currently playing or will be playing soon. These and other shortcomings of the prior art are addressed by the present disclosure.

### SUMMARY

It is to be understood that both the following general description and the following detailed description are exemplary and explanatory only and are not restrictive. Methods and systems are described for directing a user to desired content. In an aspect, a user can be directed to desired content through content bundling. As an example, in response to a user setting a digital video recorder (DVR) to record a particular content item (a program, an episode, a movie, etc.), a set of content items (programs, episodes, series, movies, etc.) based on the particular content item can also be recorded. In an aspect, the set of content items can be recorded as a file. An order in which the set of content items appear in the file can be determined by a logical sequence, such as the order in which the content items first aired and the like. In an aspect, a user can be directed to desired content (or at least potentially desired) during a particular point in current content, such as when end credits begin to roll. The desired content can be identified as desired content based on the current content or information associated with the current content. In another aspect, the desired content can be linear content that is currently playing or about to begin playing. The user can be presented with a selectable representation of the desired content which, when selected, can tune to a channel (or move to the desired content in a file) and/or set up a recording of the desired content associated with the selected selectable element.

Methods and systems are described whereby a request for content can be received and a plurality of descriptions for additional content can be retrieved based on the request for content. The additional content can be identified, for example, based on similar genre, known user interests, and the like. The plurality of descriptions for the additional content and a description of the requested content can be organized into a suggested bundle based on a logical sequence. The suggested bundle can be provided to a user along with a request for feedback. Feedback on the suggested bundle can then be received that confirms or alters the suggested bundle. A content bundle can be created based on the feedback and the suggested bundle.

In another aspect, methods and systems are described whereby a position in currently displayed content can be determined and an interactive element can be provided based on the determined position. For example, the interactive element can be provided at the start of a credit roll. The interactive element can be related to one or more linear content items, which can be selected based on the currently displayed content. The linear content items can be identified, for example, based on similar genre, known user interests, and the like. A selection of the interactive element can be received and the one or more linear content items provided and/or stored (e.g., recorded).

In a further aspect, methods and systems are described whereby a content identifier associated with a requested content item can be received and one or more content parameters associated with the content identifier can be determined. For example, content parameters such as content title, content provider, content type, content format, content release date, content length, content update frequency, content genre, content rating, the price for ordering the content, other metadata can be determined. A plurality of additional content items can be identified based on matching the one or more content parameters associated with the content identifier with one or more respective content parameters associated with the plurality of additional content items. One or more content bundles comprising the requested content item and the one or more of the plurality of additional content items can be generated based on the matching. The one or more content bundles can be organized based on a logical sequence, such as the order in which content items originally aired. The one or more content bundles can then be provided to a user for user feedback. The user feedback can be used to perform one or more actions on the one or more content bundles such as storing and/or consuming the one or more content bundles.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary system and network;

FIG. 2 is a diagram of an exemplary interface;

FIG. 3 is a diagram of an exemplary interface;

FIG. 4 is a diagram of an exemplary interface;

FIG. 5 is a diagram of an exemplary interface;

FIG. 6 is a diagram of an exemplary interface;

FIG. 7 is a diagram of an exemplary interface;

FIG. 8 is a flow chart of an exemplary method;

FIG. 9 is a flow chart of an exemplary method;

FIG. 10 is a flow chart of an exemplary method; and

FIG. 11 is a block diagram of an exemplary computing device.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, RAM, optical storage devices, solid state storage, or magnetic storage devices, cloud based devices, and other external devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks.

The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The present disclosure relates to methods and systems for directing a user to desired content. Desired content can be content that is in some way related to and/or associated with content that the user is already consuming or has already consumed. Desired content can also be content that is in some way related to and/or associated with known user preferences for content (e.g., a program title, a program start time, a program end time, a program run time, a program genre, a program subgenre, a program parental rating, a program critical rating, a list of cast, a list of crew, a director, a producer, a production company, a distribution company, a sport, a league, an association, a team, a player, a sponsor, a channel, a day of the week, a date, a language, a plurality of information related to audio, including a soundtrack, a plurality of artists, a plurality of songs, and the like). In an aspect, a user can be directed to desired content through content bundling. As an example, in response to a user setting a digital video recorder (DVR) to record a particular content item (e.g., television show, movie, sporting event, etc. . . . ), a set of additional content items (e.g., television shows, movies, sporting events, promotional clips, etc. . . . ) based on the particular content item can be identified and recorded. In an aspect, the particular content item and/or the set of additional content items can be recorded to a file. The order that the various content items appear in the file can be determined by a logical sequence, such as an order in which the content items first aired, a logical order in which the content can be viewed (such as in chronological or episode order, or pregame before game before post-game), length of content items, a logical order based on subject matter of the content, a logical order based on metadata associated with the content, and the like.

In another aspect, a user can be directed to desired content during a particular point in current content, such as when the end credits begin to roll, during a particular scene/type of scene, and the like. The desired content can be identified as desired content based on the current content. The desired content can be identified based on a comparison to the current content, for example, based on similar genre, known user interests, and the like. The desired content can be linear content that is currently playing or about to begin playing. In an aspect, after desired content has been identified, the user can be presented with a selectable representation of the desired content. A selectable representation can be, for example, a button, an entry in an electronic program guide, and the like. In an aspect, the selectable representation of the desired content can, when selected, tune to the channel that is currently playing or about to begin playing the desired content associated with the selected selectable element. In another aspect, the selectable representation of the desired content can, when selected, cause the desired content to be bundled and/or otherwise stored.

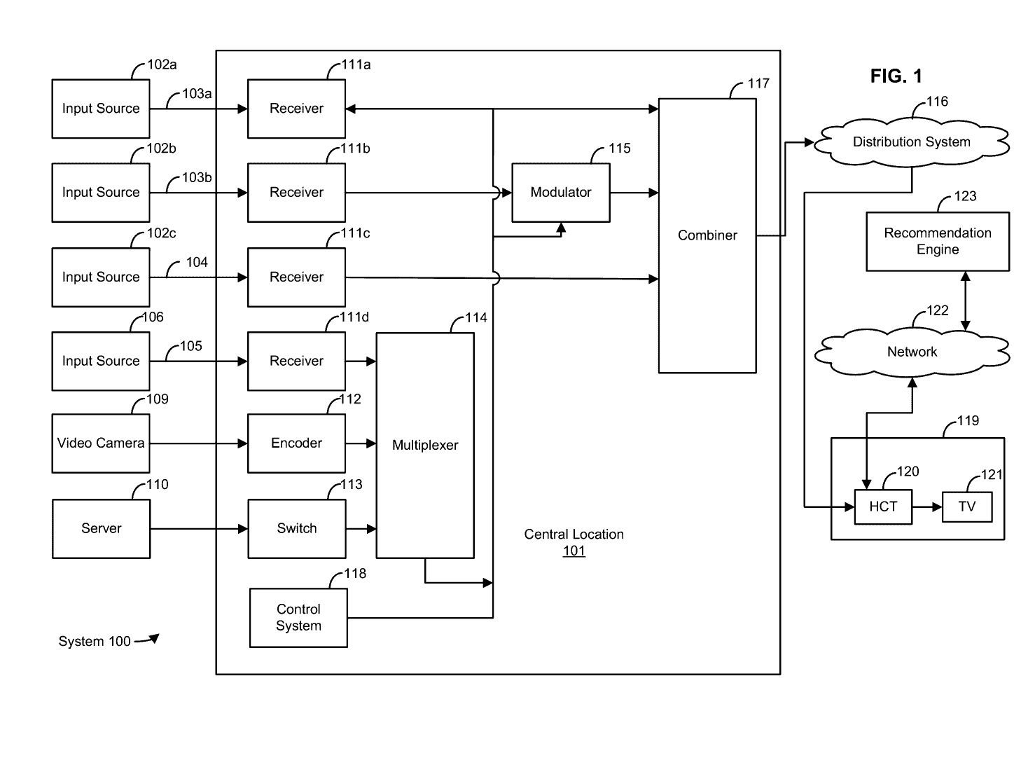

FIG. 1 illustrates various aspects of an exemplary system 100 in which the present methods and systems can operate. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The system 100 can comprise a central location 101 (e.g., a headend), which can receive content (e.g., video, audio, images, text, application files, data, input programming, and the like) from multiple sources. The central location 101 can combine the content from the various sources and can distribute the content to user (e.g., subscriber) locations (e.g., location 119) via distribution system 116.

In an aspect, the central location 101 can receive content from a variety of sources 102a, 102b, 102c. The content can be transmitted from the source to the central location 101 via a variety of transmission paths, such as wireless paths (e.g. satellite paths 103a, 103b) and terrestrial path 104. The central location 101 can also receive content from an input source 106 via a direct line 105. Other input sources can comprise capture devices, such as a video camera 109, a server 110, and/or the like. The content provided by the content sources can comprise a single content item, a portion of a content item (e.g., content fragment), a content stream, a multiplex that includes several content items, and/or the like. Content and content item can be used herein interchangeably.

The central location 101 can comprise one or a plurality of receivers 111a, 111b, 111c, 111d that are associated with one or more corresponding input sources. The central location 101 can comprise one or more encoders 112, switches 113, multiplexers, and/or the like. For example, an encoder 112 can compress, encrypt, transform, and/or otherwise encode content. As a further example, the encoder 112 can encode content based on one or more compression standards, such as MPEG. As another example, the encoder can receive content from the video camera 109 and/or other source and apply one or more encoding algorithms to the received content. A switch 113 can provide access to server 110, which can be a Pay-Per-View server, a data server, a content server, an internet router, a network system, a phone system, and the like. Some signals may require additional processing, such as signal multiplexing, prior to being modulated. Such multiplexing can be performed by multiplexer 114.

The central location 101 can comprise one or more modulators 115 for interfacing with a distribution system 116. As an example, a modulator can receive content from a receiver 111, encoder 112, multiplexer 114, and/or the like. A modulator 115 can convert the received content into a modulated output signal suitable for transmission over the distribution system 116. For example, a modulator 115 can map portions of the content to data bits expressed as signals (e.g., sinusoidal signals) at corresponding subcarrier frequencies of a data symbol. The output signals from the modulators 115 can be combined, using equipment such as a combiner 117, for input into the distribution system 116.

A control system 118 can permit a system operator to control and monitor the functions and performance of system 100. The control system 118 can interface, monitor, and/or control a variety of functions, including, but not limited to, the channel lineup for a television system, billing for each user, conditional access for content distributed to users, and the like. The control system 118 can provide input to the modulators for setting operating parameters, such as system specific MPEG table packet organization or conditional access information. The control system 118 can be located at central location 101 or at a remote location.

The distribution system 116 can distribute (e.g., multicast, unicast) content from the central location 101 to user locations, such as user location 119. The distribution system 116 can be an optical fiber network, a coaxial cable network, a hybrid fiber-coaxial network, a wireless network, a satellite system, a direct broadcast system, or any combination thereof.

There can be a multitude of user locations connected to distribution system 116. At user location 119, a decoder 120, such as a gateway or home communications terminal (HCT) can decode, if needed, the signals for display on a display device, such as on a television set (TV) 121 or a computer monitor. Those skilled in the art will appreciate that the signal can be decoded in a variety of equipment, including an HCT, a computer, a TV, a monitor, or satellite dish. In an exemplary aspect, the methods and systems disclosed can be located within, or performed on, one or more HCT's 120, TV's 121, central locations 101. DVR's, home theater PC's, and the like.

In an aspect, user location 119 is not necessarily fixed. By way of example, a user can receive content from the distribution system 116 on a mobile device such as a laptop computer, PDA, smartphone, GPS, vehicle entertainment system, portable media player, and the like.

In an exemplary embodiment, the methods and systems disclosed can be located within one or more HCT's 120. In an aspect, the one or more HCT's 120 can be in communication with a network 122. The network 122 can comprise a private network, such as a local area network. The network 122 can comprise a public network, such as the Internet. The one or more HCT's 120 can be in communication with one or more recommendation engines 123 through the network 122. The one or more recommendation engines 123 can identify and/or provide desired content items based on analysis of a content item (e.g., currently displayed content item). In an aspect, the content item forming the basis of the identified/provided desired content items can be a content item for which a request for storage has been received. In an aspect, the desired content items can be identified based on user preferences. In another aspect, the desired content items can be identified based on matching the one or more content parameters associated with the content item with one or more respective content parameters associated with a plurality of additional content items. For example, the desired content items can be identified by matching the content genre associated the content item with content genre associated with respective one or more additional content items. As a specific example, if the content item is a comedy released in a current year, the desired content items can comprise one or more additional comedies released in the current year. As another example, if the content item is a sports game (e.g., football) involving a certain team or a certain player, the desired content items can comprise one or more additional sport games involving the same game and/or the same player. The desired content items can be retrieved from local storage and/or remote storage. In an aspect, the desired content items can comprise linear content and/or non-linear content. The desired content items can be video only, audio only, video and synchronized audio, text, pictures, documents, and/or any combination of the foregoing.

In response to the request for storing the content item, the retrieved desired content items and the content item can be stored as a content bundle. The content bundle can be a grouping of the content item and the desired content items that is organized according to a logical sequence. In an aspect, the logical sequence can comprise an order in which the content originally aired, an order in which the content was originally made available to the public, an intended viewing order, an ordering of episodes (content items) by episode number, an ordering of episodes by a combination of season number and episode number, an ordering based on a strength of recommendation, an ordering based on an attribute of the content, and the like. In an aspect, the content item forming the basis of the provided desired content items can be a currently viewed content item. In response to detecting an event (e.g., start of a credit roll) in the currently viewed content item, the provided desired content items can be provided by providing selectable elements corresponding to the desired content items. The desired content items can be linear content items that are currently playing or playing soon. Each selectable element, when selected, can cause a device, such as HCT 120, to tune to a linear channel on which the corresponding desired content item is playing.

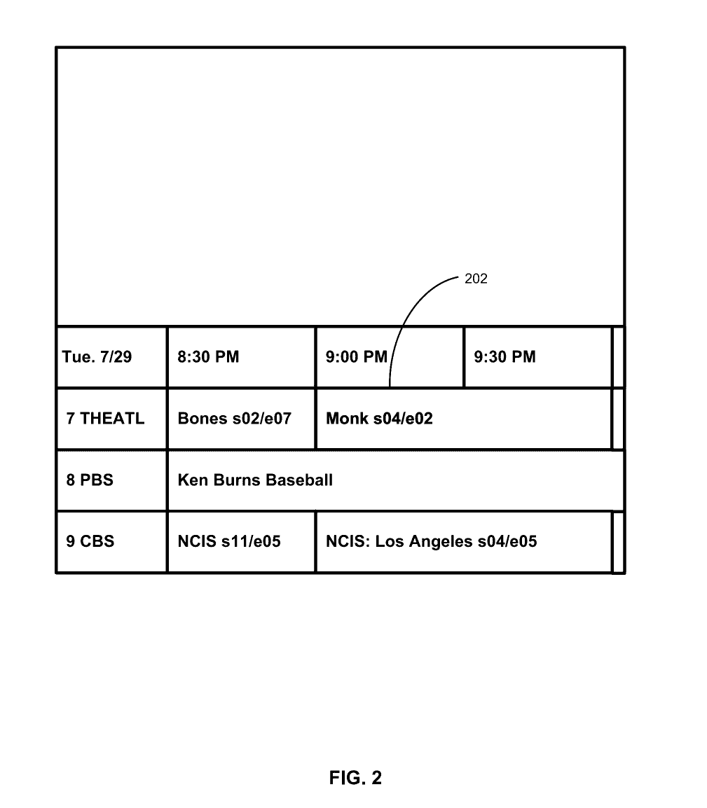

FIG. 2 illustrates an example interface allowing a user to select content for storage, for example by engaging selectable element 202. The methods and systems described herein can be implemented with any interface that allows a user to select content for storage, including an electronic programming guide, a search engine, a recommendation engine, a public database, a private database, a social media platform, an email server, or other electronic means. As shown in FIG. 2, the user can position and engage the selectable element 202 to select content that the user wishes to store. In an aspect, the interface can comprise an electronic programming guide, displaying content in a traditional grid form showing multiple channels with content arranged chronologically.

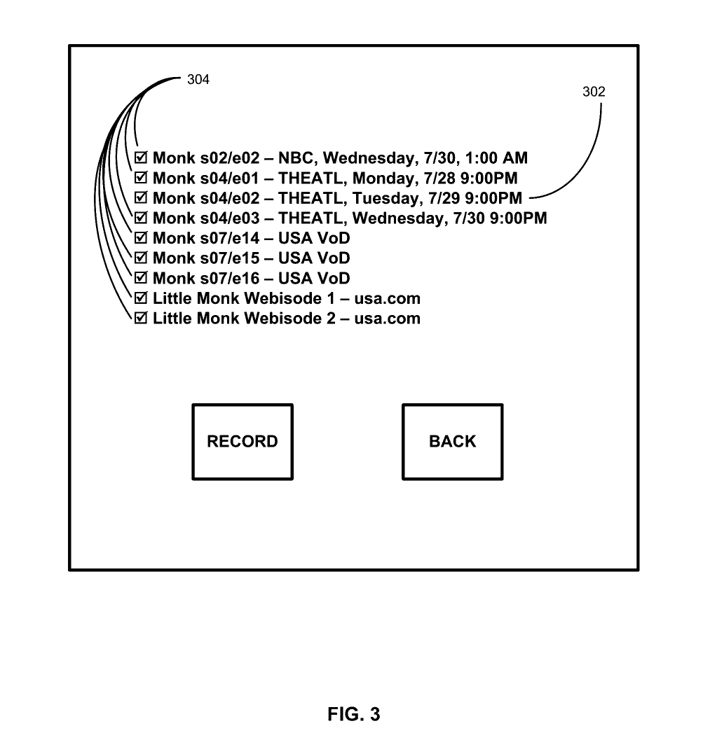

FIG. 3 illustrates an example interface displaying representations of a suggested content bundle. In an aspect, a recommendation engine can be queried with the content selected for storage (e.g., the element selected by engaging selectable element 202) as input. A representation of the results 304 of the recommendation engine query along with a representation of the selected content 302 can be presented in an order based on a logical sequence. The logical sequence can comprise an order in which the content originally aired, an order in which the content was originally made available to the public, an intended viewing order, an ordering of episodes (content items) by episode number, an ordering of episodes by a combination of season number and episode number, an ordering based on a strength of recommendation, an ordering based on an attribute of the content, and the like. In an aspect, an attribute of the content can be a resolution (e.g., standard definition, high definition, ultra high definition, etc.), a speed (e.g., a frame rate, a bit rate, etc.), an encoding type, a content type (e.g., video only, audio only, audio and video, etc.), a length, any other attribute of the content, or any combination of the foregoing. The logical sequence can comprise ordering based on a source of the content. In an aspect, the source can provide the content linearly, on-demand, or in any other fashion. In an aspect, the source can be a head-end, a video-on-demand server, a server connected to a network (e.g., a web server), or any other device for distributing content. In an aspect, the source of the content can be one or more particular channels, websites, or any other distributor of content. In an aspect, a user can specify the logical sequence or a priority of logical sequences that can form the basis of the logical order. In an aspect, a user can reorder the presented representation of the suggested bundled content (302, 304). In an aspect, the representation of the content (302, 304) can include information about the content, such as a title, a source, a date and a time when it will be recorded, etc. In an aspect, a filter system can be applied to the source of the content. For example, different level of parental controls can be applied to the source of the content based on profile (e.g., age) of the user. As such, only age-appropriate content can be selected and/or recommended to the user.

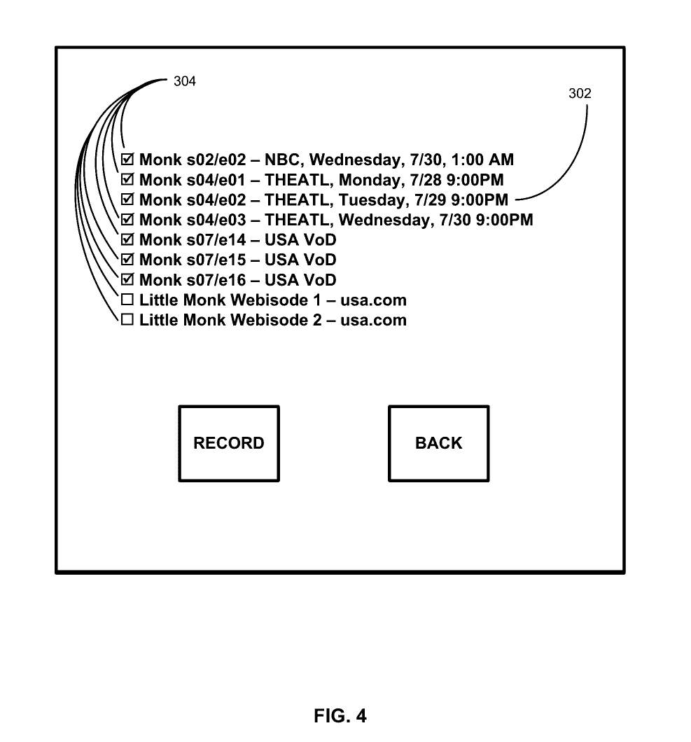

FIG. 4 illustrates an example interface allowing a user to modify the suggested content bundle. For example, the user can choose to remove (uncheck) some of the representations of the content 302, 304 which would result in removal of those particular content items from the suggested content bundle. In another aspect, the user can reorder the representations of the content 302, 304 which would result in reordering of the content items in the suggested content bundle. In a further aspect, the user can add representations of content not shown in the interface which would result in addition of those particular content items to the suggested content bundle. For example, the user can select a representation of the results of the recommendation engine 304 for use as input for a second recommendation query, and add representations of the results of the second recommendation query to the suggested content bundle.

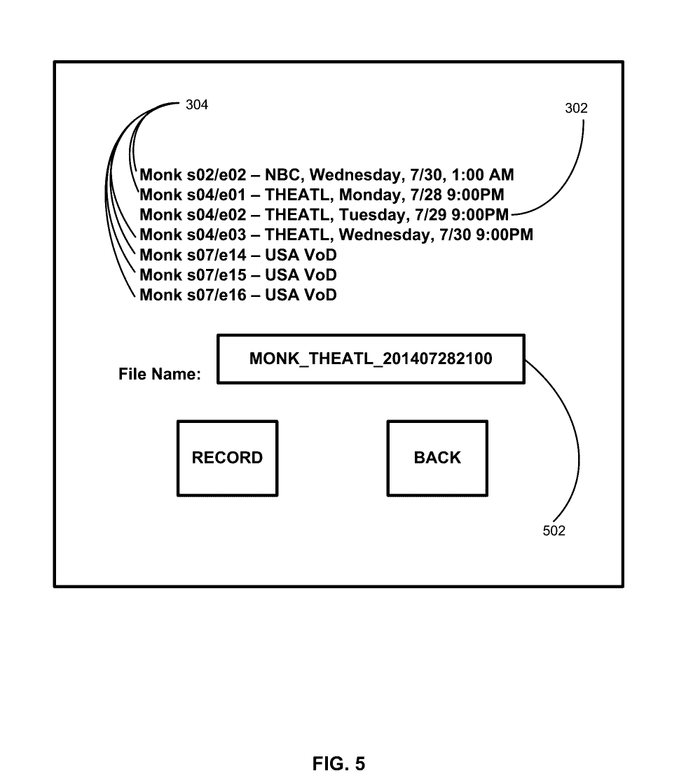

FIG. 5 illustrates an example interface displaying a file name for a content bundle 502 and a representation of the content items 302, 304 comprising the content bundle. In an aspect, the content items represented by the representations 302, 304 can be delimited from each other within the content bundle 502. For example, a chapter can be generated within the content bundle 502 for each content item that is represented by the representations 302, 304. For example, a first chapter can comprise a first content item represented by the content representation appearing first in the sequence of content representations 302, 304, a second chapter can comprise a second content item represented by the content representation appearing second in the sequence of content representations 302, 304, and so on. In an aspect, a file name of the content bundle 502 can be generated based on the representation of the content selected for storage 302. For example, a file name of the content bundle 502 can comprise a program name, an episode name and/or number, a source, a time and/or date originally aired, a time and/or date recorded, any other attributes from the representation of the content items selected for storage, or any combination of the foregoing. In an aspect, a source can comprise a channel, a website, an indication of whether a content item was retrieved from an on demand service, any other source, or any combination of the foregoing. In an aspect, a file name of the content bundle 502 can be generated based on attributes relating to the request for storage. In an aspect, attributes relating to the request for storage can comprise a time and/or date of the request, a name associated with a profile associated with the request, any other attribute relating to the request for storage, or any combination of the foregoing. In an aspect, a file name of the content bundle 502 can be generated based on any combination of the representation of the content items selected for storage, attributes relating to the request for storage, or any other attributes useful for separating one content bundle from another. In an aspect, a user can create/change a file name for the content bundle 502.

In an aspect, each content item corresponding to a selected representation of content 302, 304 is stored. In an aspect the content items can be stored locally on a user device (e.g., a DVR). In another aspect, the content items can be stored on a network-accessible storage medium. For example, the content items can be stored at a content server for use with a cloud-based DVR. In an aspect, linear content can be recorded at the time the content is aired. In an aspect, non-linear content (e.g., VOD content) can be stored in response to an approval of the content bundle.

In an aspect, the content bundle can comprise a single content file, including one or more chapters, with each chapter corresponding to a content item represented by one of the representations 302,304. In an aspect, in response to approval of the content bundle, non-linear content items contained in the content bundle can be stored and linear content items contained in the content bundle can be scheduled to record. In an aspect, once each of the content items contained in the content bundle is stored, the content bundle can be formed by ordering the content items and combining the content items into a single file. In another aspect, the content bundle can be formed progressively, such that each content item contained in the content bundle is added to the bundle as it is stored. For example, a non-linear content item can be added to the content bundle when it has been stored, and a linear content item can be added to the content bundle once it has been fully recorded. In an aspect, delimiters (e.g., chapter breaks) can be inserted into the bundle between each of the content items.

In another aspect the content bundle can comprise a directory structure storing one or more content files, with each of the one or more content files corresponding to a content item represented by one of the representations 302,304. In an aspect, each content file can be stored individually within the directory structure of the content bundle. For example, in response to approval of the content bundle, non-linear content items contained in the content bundle can be stored and linear content items contained in the content bundle can be scheduled to record. In an aspect, the content files can be linked in a logical sequence. For example, metadata for each content file can be used to specify a subsequent content file that should be displayed.

The content items stored within the content bundle can be stored in any logical order or logical sequence. In an aspect, the logical sequence can comprise an order in which the content items were originally available. In an aspect, the logical sequence can comprise an order in which the content items first aired. In an aspect, the logical sequence can comprise an order of numbered episodes of content items. In an aspect, additional parameters, such as content name can be used to determine a logical sequence for ordering content items.

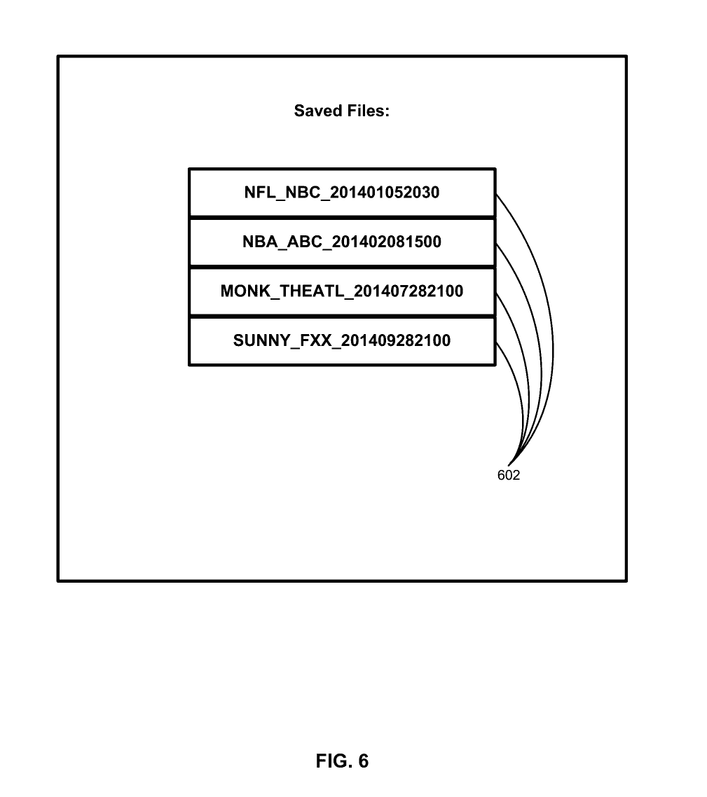

FIG. 6 illustrates an example interface for displaying a plurality of content bundles 602. Each content bundle 602 can comprise content items that were grouped in response to a request for content storage in accordance with the methods and systems described herein. In an aspect, a user can select one of the plurality of content bundles 602 to cause a particular content bundle to play. In an aspect, once one of the plurality of content bundles 602 plays, a user can navigate within the one of the plurality of content bundles 602 by switching chapters.

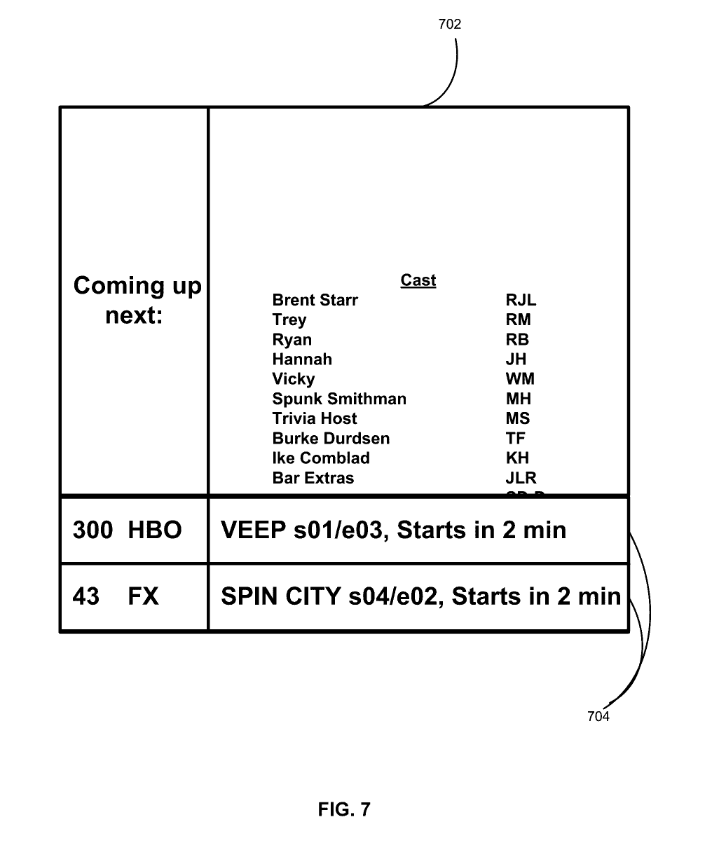

FIG. 7 illustrates an example interface providing a plurality of selectable or interactive elements. In an aspect, a content item can be displayed and a position within the content item can be determined. For example, a position within the content item can be an event such as a beginning of a credit roll, a scene, a commercial, and the like. In an aspect, in response to determining the position in the content item, the content item can be relegated to a smaller display window, such as window 702. In an aspect, in response to determining the position in the content item, a plurality of selectable or interactive elements can be presented, such as selectable elements 704. In an aspect, the selectable elements 704 can represent linear content item(s) that are related to the currently playing content item that are also currently playing or are playing soon. In an aspect, the content items represented by the selectable elements 704 can be related to the content item currently displayed in window 702. For example, in response to determining that the position of the content item currently displayed is the beginning of a credit roll, the content item can be relegated to the window 702, related linear content items can be determined, and the plurality of selectable elements 704 linking to the related linear content items that are playing, or playing soon, that are related to the content item in window 702. In response to a user selecting one of the plurality of selectable elements 704, a user device can tune to the channel showing, or about to show, the content item represented by the selected selectable element. In an aspect, in response to a user selecting one of the plurality of selectable elements 704, the user can indicate a desire to store the content item. In an aspect, in response to indicating a desire to store the content item represented by the selectable element, a recommendation engine can be queried for related content items and a content bundle can be created, as explained above.

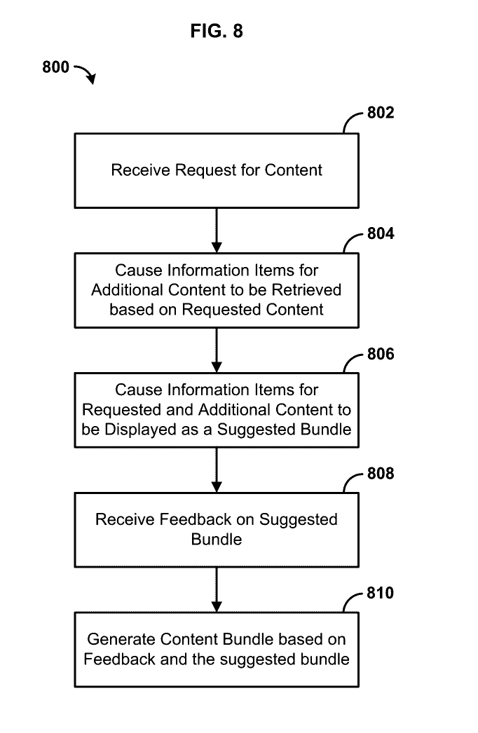

FIG. 8 illustrates an exemplary flow chart 800. At step 802, a request for content can be received. In an aspect, a request for content can comprise a request to store content. The request for content can be transmitted from a television, a set-top box, a tablet, a smartphone, a PDA, a computer, and the like. A request to store content can comprise entering and/or transmitting the request to store content in local storage. A request to store content can comprise transmitting the request to store content on remote storage, for example, external servers, cloud storage, and the like. For example, the request to store content can be transmitted to an electronic programming guide, a search engine, a recommendation engine, a public database, a private database, a social media platform, an email server, or other electronic means. In an aspect, the content can be linear content. In an aspect, the content can be non-linear content. Content can be video only, audio only, video and synchronized audio, text, pictures, documents, and/or any combination of the foregoing. Content can comprise personal content, privately shared content, publicly free content, public purchasable content, subscribed content, authenticated content, chaptered content, and the like.

At step 804, a plurality of information items associated with additional content can be caused to be retrieved based on the requested content. The additional content can comprise linear content. The additional content can comprise non-linear content. The additional content can be video only, audio only, video and synchronized audio, text, pictures, documents, and/or any combination of the foregoing. The additional content can be from a QAM channel, a website, a video-on-demand system, a pay-per-view system, and/or any combination of the foregoing. A description of content can comprise a program name, an episode name and/or number, a source, a time and/or date originally aired, a time and/or date the content will air, any other information about the content, or any combination of the foregoing.

At step 806, the plurality of information items associated with the additional content and an information item associated with the requested content can be caused to be displayed as a suggested bundle based on a logical sequence. As an example, the plurality of descriptions of additional content and a description of the requested content can comprise a content playlist organized based on a logical sequence. In an aspect, the logical sequence can comprise an order in which the requested content and additional content were originally available. In an aspect, the logical sequence can comprise an order in which the requested content and additional content first aired. In an aspect, the logical sequence can comprise an order of numbered episodes. In an aspect, the plurality of descriptions for additional content and a description of the requested content can be transmitted to one or more user devices that initiated the request for content. The plurality of descriptions for additional content and a description of the requested content (e.g., a content playlist) can be presented in the form of anonymous notifications, email messages, pop-up messages, social network messages, and the like.

At step 808, feedback on the suggested bundle can be received. In an aspect, the feedback can confirm the suggested bundle. In an aspect, the feedback can alter the suggested bundle. In an aspect, the feedback can cause a description for additional content to be removed from the suggested bundle. In an aspect, the feedback can cause a description for further content to be added to the suggested bundle. For example, the feedback can comprise adding or removing one or more key words in the request for content. As another example, the feedback can comprise further broadening or narrowing one or more criteria used in the request for content. In an aspect, the feedback can be received through a remote control, a smart phone, a tablet, a keyboard, a mouse, a joystick, a voice recognition system, any other way of giving feedback, or any combination of the foregoing.

At step 810, a content bundle can be generated based on the feedback and the suggested bundle. The content bundle can be a content bundle as previously described herein.

Content in the content bundle can comprise video only, audio only, video and synchronized audio, text, pictures, documents, and/or any combination of the foregoing.

Content in the content bundle can be from a QAM channel, an IP channel, an out of band channel, a website, a video-on-demand system, a pay-per-view system, and/or any combination of the foregoing. The content bundle can be saved for later viewing by a user or can be played immediately.

In an aspect, the content bundle can be stored locally on a digital video recorder (DVR), stored on a server for use with a cloud-based DVR, or the like. In an aspect, the content bundle can be recorded substantially in real time. For example, linear content can be recorded as the one or more selections 302, 304 are broadcast. Non-linear time content, such as video on demand content, can be stored in response to the feedback to the suggested bundle in step 808 (e.g., in response to confirmation of the suggested bundle).

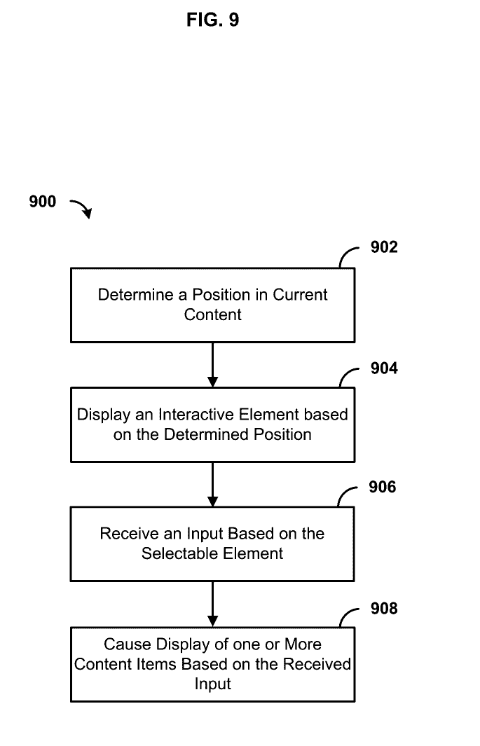

FIG. 9 illustrates an exemplary flow chart 900. At step 902, a position for displaying a selectable or interactive element in a current contently displayed item can be determined. A current content item can be a content item that a user is actively consuming. In an aspect, the current content item can comprise linear content. In an aspect, the current content item can comprise non-linear content. In an aspect, the position can be an event such as a beginning of a credit roll, a scene, a commercial, and the like. In an aspect, the position in the current content item can be determined by interpreting a message in metadata. In an aspect, the position in the current content item can be determined by interpreting a message in signals (e.g., closed captions, metadata, in band signal, time code, automatic content recognition signal, etc.) in the current content item.

At step 904, a selectable or interactive element can be provided based on the determined position. The selectable or interactive element can be a user engageable graphical user interface element that, when engaged by a user, causes an action to be performed (e.g., play content, view content recommendations, etc.). In an aspect, the selectable or interactive element can be related to a linear content item that is currently playing or about to begin playing. In another aspect, the selectable or interactive element can be related to a non-linear content item.

In an aspect, when the selectable or interactive element is selected, one or more additional content items can be identified, viewed, and/or stored. The one or more additional content items can be linear content items, non-linear content items, or a combination thereof. In an aspect, the one or more additional content items can be identified based on user preferences. In another aspect, the one or more additional content items can be identified based on matching one or more content parameters (e.g., content genre, team name, team player, content release date, etc.) of the current content item presented via the selectable element with one or more respective content parameters (e.g., content genre, team name, team player, content release date, etc.) of a plurality of content items provided by one or more content providers. For example, if the selectable element shows a baseball game involving a certain team (e.g., Red Sox) is about to start in two minutes on a certain linear channel, the additional content can comprise one or more baseball games involving the certain team (e.g., Red Sox) on other linear channels, or other content related to the certain team (e.g., Red Sox). In an aspect, the selectable element can be an entry in an electronic programming guide, a recommendation engine, a public database, a private database, a social media platform, an email server, a video-on-demand system, a pay-per-view system, and/or other electronic means.

In an aspect, a linear content item related to the current content item can be presented on a channel that is different from a currently tuned channel. In an aspect, selection of the selectable or interactive element can cause tuning to the channel presenting the related linear content item. In an aspect, selection of the selectable or interactive element can cause the related linear content item to be stored in a content bundle with the one or more additional content items as previously described herein. In an aspect, the selectable or interactive element can represent linear content items currently playing or playing soon. By way of example, in response to determining that the position of the currently displayed content item being displayed is the beginning of a credit roll, the current content item can be relegated to a portion of a display device (e.g., smaller window 702) and a selectable or interactive element (e.g., selectable element 704) can be displayed to a user in another portion of the display device that links to related linear content items that are currently playing or playing soon.

At step 906, input based on the selectable or interactive element can be received. In an aspect, the input can be a user-made selection of the selectable or interactive element. In an aspect, a selection of the selectable or interactive element can indicate the user is interested in consuming and/or storing one or more additional content items (e.g., as a content bundle).

At step 908, the one or more additional content items can be displayed based on the received input. In response to a user selecting the selectable or interactive element, a user device (e.g., set-top box) can tune to a channel that is playing, or will soon be playing, the additional content item selected via the selected selectable element. In an aspect, in response to a user selecting the selectable or interactive element, the user can indicate a desire to store one or more additional content items associated with the current content item. In response to indicating a desire to store the one or more content items associated with the current content item, a recommendation engine can be queried to further identify the one or more additional content items and a content bundle can be created, as explained above.

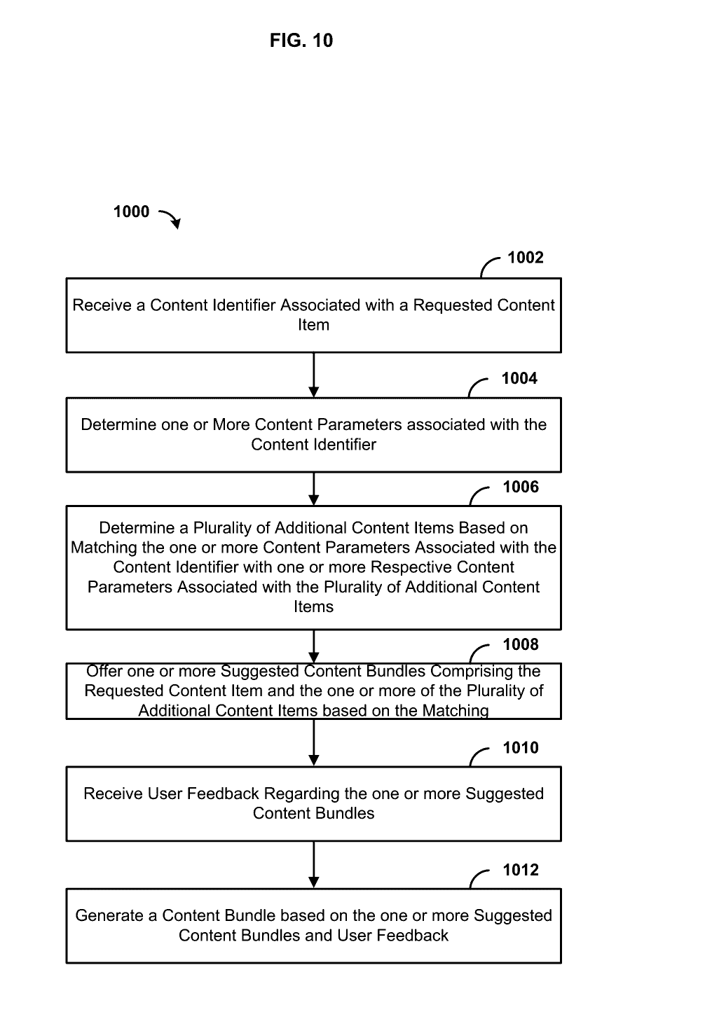

FIG. 10 illustrates an exemplary flow chart 1000. At step 1002, a content identifier associated with a requested content item can be received. The content identifier can be used to locate the requested content item in a linear and/or a non-linear content database. In an aspect, the requested content item can be a linear content item. In another aspect, the requested content item can be a non-linear content item. The requested content item can be video only, audio only, video and synchronized audio, text, pictures, documents, and/or any combination of the foregoing. The requested content item can be stored locally or remotely. In an aspect, the content identifier can be received when a user selects the requested content item via a selectable element. The content identifier can be received via a QAM channel, an IP channel, an out of band channel, a website, a video-on-demand system, a pay-per-view system, and/or any combination of the foregoing.

At step 1004, one or more content parameters associated with the content identifier can be determined. In an aspect, the requested content item can be retrieved based on the content identifier and one or more content parameters of the requested content item can be determined. In an aspect, the one or more content parameters associated with the content identifier can comprise content title, content provider, content type (e.g. pay per view content, video on demand content), content format (e.g., digital, analog), content release date, content update frequency, content genre (e.g. romance, comedy, sports, etc.), content rating (e.g. PG, R, PG-13), the price for ordering the content, other metadata (e.g., name of a sport team, leading actor, leading actress, etc.) associated with the content identifier, and the like.

At step 1006, a plurality of additional content items can be identified based on matching the one or more content parameters associated with the content identifier with one or more respective content parameters associated with the plurality of additional content items. In an aspect, the plurality of additional content items can be identified by matching the content genre associated the content identifier with content genre associated with respective one or more additional content items. For example, if the requested content item is a comedy released in a current year, the plurality of additional content items can comprise one or more additional comedies released in the current year, one or more comedies released in other years, one or more other content items released in the current year, etc. As another example, if the requested content item is a sports game (e.g., football) involving a certain team or a certain player, the plurality of additional content items can comprise, for example, one or more additional sports games involving the same game, additional sports games involving the same team and/or player, and/or additional content (e.g., highlight reels, pre-game and/or post-game content, news programs, special interest stories, etc.) related to the team and/or any of its players. The plurality of additional content items can retrieved from local storage and/or remote storage. In an aspect, the plurality of additional content items can comprise linear content and/or non-linear content. The plurality of additional content items can be video only, audio only, video and synchronized audio, text, pictures, documents, and/or any combination of the foregoing.

At step 1008, one or more suggested content bundles comprising the requested content item and one or more of the plurality of additional content items can be offered based on the matching. As an example, a suggested content bundle comprising one or more identified comedies can be offered. As another example, a suggested content bundle comprising one or more sports games and/or additional content involving a certain team or a certain player can be offered.

In an aspect, the one or more suggested content bundles can be organized based on a logical sequence. By way of example, the logical sequence can comprise one or more of, an order in which the requested content item and the plurality of additional content items were originally aired, an order in which the requested content item and the plurality of additional content items were originally made available to the public, an ordering of episodes (content items) by episode number, an ordering of episodes by a combination of season number and episode number, an ordering based on a strength of recommendation, an ordering based on an attribute of the requested content item and the plurality of additional content items. In an aspect, an attribute can be a resolution (e.g., standard definition, high definition, ultra high definition, etc.), a speed (e.g., a frame rate, a bit rate, etc.), an encoding type, a content type (e.g., video only, audio only, audio and video, etc.), a length, any other attribute of content, or any combination of the foregoing.

At step 1010, user feedback regarding the one or more suggested content bundles can be received. The one or more suggested content bundles can be displayed via a QAM channel, an IP channel, an out of band channel, a website, a video-on-demand system, a pay-per-view system, and/or any combination of the foregoing. In an aspect, the one or more suggested content bundles can be marked and provided to a user based on the one or more content parameters used to identify the plurality of additional content items.

For example, the one or more suggested content bundles can be marked as “common genre,” “common leading actor,” “common team,” “common player,” and the like. The user can further select one or more suggested content bundles according to how the one or more suggested content bundles are marked.

In an aspect, feedback can be received from a user. The feedback can comprise selecting one or more specifically marked suggested content bundles. In another aspect, the feedback can alter the one or more suggested content bundles provided to the user.

For example, the feedback can cause additional content items to be added and/or removed from the one or more suggested content bundles. In an aspect, the feedback can be used to further modify the one or more suggested content bundles. For example, the feedback can comprise further broadening or narrowing one or more criteria associated with one or more parameters in identifying the plurality of additional content items. In an aspect, the feedback can be received through a remote control, a smart phone, a tablet, a keyboard, a mouse, a joystick, a voice recognition system, any other way of giving feedback, or any combination of the foregoing. The feedback can result in storage and/or playback of the one or more suggested content bundles.

At step 1012, a content bundle is generated based on the user feedback and the one or more suggested content bundles. The content bundle can be a content bundle as previously described herein. Content in the content bundle can comprise video only, audio only, video and synchronized audio, text, pictures, documents, and/or any combination of the foregoing. Content in the content bundle can be from a QAM channel, an IP channel, an out of band channel, a website, a video-on-demand system, a pay-per-view system, and/or any combination of the foregoing. The content bundle can be saved for later viewing by a user or can be played immediately.

In an aspect, the content bundle can be stored locally on a user device (e.g., a digital video recorder (DVR)), stored on a server for use with a cloud-based DVR, or the like. In an aspect, the content bundle can be recorded substantially in real time. For example, linear content can be scheduled for recording in response to the feedback to the one or more content items, and recorded as the one or more selected content items are broadcast. Non-linear time content, such as video on demand content, can be stored in response to the feedback to the one or more suggested content bundles (e.g., in response to confirmation of the suggested bundle).

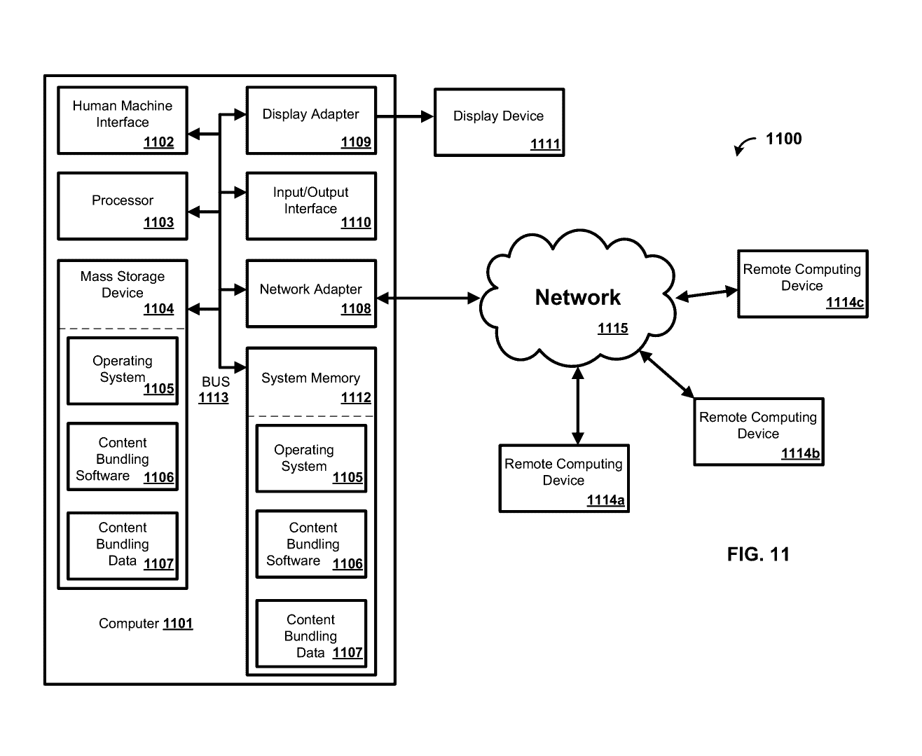

In an exemplary aspect, the methods and systems can be implemented on a computer 1101 as illustrated in FIG. 11 and described below. By way of example, server 110 of FIG. 1 can be a computer 1101 as illustrated in FIG. 11. Similarly, the methods and systems disclosed can utilize one or more computers to perform one or more functions in one or more locations. FIG. 11 is a block diagram illustrating an exemplary operating environment 1100 for performing the disclosed methods. This exemplary operating environment 1100 is only an example of an operating environment and is not intended to suggest any limitation as to the scope of use or functionality of operating environment architecture. Neither should the operating environment 1100 be interpreted as having any dependency or requirement relating to any one or combination of components illustrated in the exemplary operating environment 1100.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems.

Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, and/or the like that perform particular tasks or implement particular abstract data types. The disclosed methods can also be practiced in grid-based and distributed computing environments where tasks are performed by remote processing devices that are linked through a communications network. In a distributed computing environment, program modules can be located in local and/or remote computer storage media including memory storage devices.

Further, one skilled in the art will appreciate that the systems and methods disclosed herein can be implemented via a general-purpose computing device in the form of a computer 1101. The computer 1101 can comprise one or more components, such as one or more processors 1103, a system memory 1112, and a bus 1113 that couples various components of the computer 1101 including the one or more processors 1103 to the system memory 1112. In the case of multiple processors 1103, the system can utilize parallel computing.

The bus 1113 can comprise one or more of several possible types of bus structures, such as a memory bus, memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 1113, and all buses specified in this description can also be implemented over a wired or wireless network connection and one or more of the components of the computer 1101, such as the one or more processors 1103, a mass storage device 1104, an operating system 1105, content bundling software 1106, content bundling data 1107, a network adapter 1108, system memory 1112, an Input/Output Interface 1110, a display adapter 1109, a display device 1111, and a human machine interface 1102, can be contained within one or more remote computing devices 1114a,b,c at physically separate locations, connected through buses of this form, in effect implementing a fully distributed system.

The computer 1101 typically comprises a variety of computer readable media. Exemplary readable media can be any available media that is accessible by the computer 1101 and comprises, for example and not meant to be limiting, both volatile and non-volatile media, removable and non-removable media. The system memory 1112 can comprise computer readable media in the form of volatile memory, such as random access memory (RAM), and/or non-volatile memory, such as read only memory (ROM). The system memory 1112 typically can comprise data such as content bundling data 1107 and/or program modules such as operating system 1105 and content bundling software 1106 that are accessible to and/or are operated on by the one or more processors 1103.

In another aspect, the computer 1101 can also comprise other removable/non-removable, volatile/non-volatile computer storage media. The mass storage device 1104 can provide non-volatile storage of computer code, computer readable instructions, data structures, program modules, and other data for the computer 1101.

For example, a mass storage device 1104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1104, including by way of example, an operating system 1105 and content bundling software 1106. One or more of the operating system 1105 and content bundling software 1106 (or some combination thereof) can comprise elements of the programming and the content bundling software 1106. Content bundling data 1107 can also be stored on the mass storage device 1104. Content bundling data 1107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple locations within the network 1115.

In another aspect, the user can enter commands and information into the computer 1101 via an input device (not shown). Examples of such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices can be connected to the one or more processors 1103 via a human machine interface 1102 that is coupled to the bus 1113, but can be connected by other interface and bus structures, such as a parallel port, game port, an IEEE 1394 Port (also known as a Firewire port), a serial port, network adapter 1108, and/or a universal serial bus (USB).

In yet another aspect, a display device 1111 can also be connected to the bus 1113 via an interface, such as a display adapter 1109. It is contemplated that the computer 1101 can have more than one display adapter 1109 and the computer 1101 can have more than one display device 1111. For example, a display device 1111 can be a monitor, an LCD (Liquid Crystal Display), light emitting diode (LED) display, television, smart lens, smart glass, and/or a projector. In addition to the display device 1111, other output peripheral devices can comprise components such as speakers (not shown) and a printer (not shown) which can be connected to the computer 1101 via Input/Output Interface 1110. Any step and/or result of the methods can be output in any form to an output device. Such output can be any form of visual representation, including, but not limited to, textual, graphical, animation, audio, tactile, and the like. The display 1111 and computer 1101 can be part of one device, or separate devices.

The computer 1101 can operate in a networked environment using logical connections to one or more remote computing devices 1114a,b,c. By way of example, a remote computing device 1114a,b,c can be a personal computer, computing station (e.g., workstation), portable computer (e.g., laptop, mobile phone, tablet device), smart device (e.g., smartphone, smart watch, activity tracker, smart apparel, smart accessory), security and/or monitoring device, a server, a router, a network computer, a peer device, edge device or other common network node, and so on. Logical connections between the computer 1101 and a remote computing device 1114a,b,c can be made via a network 1115, such as a local area network (LAN) and/or a general wide area network (WAN). Such network connections can be through a network adapter 1108. A network adapter 1108 can be implemented in both wired and wireless environments. Such networking environments are conventional and commonplace in dwellings, offices, enterprise-wide computer networks, intranets, and the Internet.

For purposes of illustration, application programs and other executable program components such as the operating system 1105 are illustrated herein as discrete blocks, although it is recognized that such programs and components can reside at various times in different storage components of the computing device 1101, and are executed by the one or more processors 1103 of the computer 1101. An implementation of content bundling software 1106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ artificial intelligence (AI) techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
receiving a request for content;
causing a plurality of information items associated with additional content to be retrieved based on the requested content;
causing the plurality of information items associated with the additional content and an information item associated with the requested content to be displayed as a suggested bundle based on a logical sequence;
receiving feedback on the suggested bundle, wherein the feedback confirms or alters the suggested bundle; and
generating a content bundle based on the feedback and the suggested bundle.

2. The method of claim 1, wherein receiving the request for content comprises receiving a request to store the content.

3. The method of claim 1, wherein the requested content is linear content.

4. The method of claim 1, wherein the additional content comprises at least one of linear content and non-linear content.

5. The method of claim 4, wherein generating the content bundle based on the feedback and the suggested bundle comprises:
storing the non-linear additional content in response to receiving the feedback on the suggested bundle;
scheduling recording of the linear additional content in response to receiving the feedback on the suggested bundle;
ordering the stored non-linear additional content and the recorded linear additional content based on the logical sequence; and
storing the content bundle by combining the ordered and stored additional content into a single file.

6. The method of claim 5, wherein the stored non-linear additional content and the recorded linear additional content are ordered at a time after the linear additional content has been fully recorded and all items of non-linear additional content have been stored.

7. The method of claim 1, wherein generating the content bundle based on the feedback and the suggested bundle comprises:
storing the additional content;
ordering the stored additional content based on the logical sequence; and
storing the content bundle by combining the ordered and stored additional content into a single file.

8. The method of claim 1, wherein the logical sequence comprises one or more of an order in which the requested content and the additional content were originally available, an order in which the requested content and the additional content first aired, and an order of numbered episodes.

9. The method of claim 1, further comprising:
presenting the stored content bundle;
determining a position in the content bundle; and
providing a selectable element based on the determined position, wherein selecting the selectable element causes presentation of another content item.

10. A method comprising:
determining a position for displaying an interactive element in a currently displayed content item;
displaying the interactive element based on the determined position, wherein the interactive element allows for selection of one or more linear content items, and wherein the one or more linear content items are selected based on the currently displayed content item;
receiving an input based on the interactive element; and
causing display of the one or more linear content items based on the received input.

11. The method of claim 10, wherein the current content item comprises one of a linear content item and a non-linear content item.

12. The method of claim 10, wherein the determined position is one or more of a beginning of a credit roll, a beginning of a scene, and a commercial.

13. The method of claim 10, further comprising causing the one or more linear content items to be stored in a content bundle in response to receipt of the input.

14. The method of claim 10, wherein the interactive element comprises an entry in an electronic programming guide.

15. The method of claim 10, wherein causing display of the one or more linear content items comprises causing display of the one or more linear content items on a channel that is different from a currently tuned channel.

16. The method of claim 10, wherein causing display of the one or more linear content items further comprises causing a device to tune to a channel presenting the one or more linear content items.

17. The method of claim 10, wherein determining a position in the current content item comprises interpreting one or more of metadata and closed captions.

18. A method comprising:
receiving a content identifier associated with a requested content item;
determining one or more content parameters associated with the content identifier;
determining a plurality of additional content items based on matching the one or more content parameters associated with the content identifier with one or more respective content parameters associated with the plurality of additional content items;
offering one or more suggested content bundles comprising the requested content item and one or more of the plurality of additional content items based on the matching;
receiving user feedback regarding the one or more suggested content bundles; and
generating a content bundle based on the one or more suggested content bundles and the user feedback.

19. The method of claim 18, wherein generating the content bundle based on the one or more suggested content bundles and the user feedback comprises:
storing the requested content item and the one or more of the plurality of additional content items;
ordering the requested content item and the one or more stored additional content items based on a logical sequence; and
storing the content bundle by combining the ordered and stored requested content item and additional content items into a single file.

20. The method of claim 19, wherein the logical sequence comprises one or more of, an order in which the requested content and the additional content were originally available, an order in which the requested content and the additional content first aired, and an order of numbered episodes.
